(19) United States
(12) Patent Application Publication
(10) Pub. No.: US 2006/0264534 A1
(43) Pub. Date: Nov. 23, 2006

(54) Inkjet inks having reduced bronzing

(76) Inventors: Zeying Ma, San Diego, CA (US); Yubai Bi, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/067,436

(22) Filed: May 23, 2005

(51) Int. Cl. C03C 17/00

(52) U.S. Cl. 523/160; 524/492; 524/497

(57) ABSTRACT

An inkjet ink having reduced bronzing. The inkjet ink includes a pigment and at least one additive selected from the group consisting of a water-soluble polymer, a polymer hydrosol, a latex, a silica colloid, a titanium oxide pigment, and mixtures thereof. The at least one additive is selected to provide reduced bronzing to the inkjet ink.

### FIELD OF THE INVENTION

The present invention relates to an inkjet ink having reduced bronzing when printed. More specifically, the present invention relates to an inkjet ink that includes a bronzing reducing additive selected from the group consisting of a water-soluble polymer, a polymer hydrosol, a latex, a silica colloid, a titanium oxide pigment, or mixtures thereof.

### BACKGROUND OF THE INVENTION

With the recent rise in digital photography, the desire to print images having photographic quality at a reasonable cost is increasing. However, when printing photographic quality images, inkjet print quality still falls short of that produced by silver halide photography. Inkjet printing is a nonimpact process of printing text or images by depositing inkjet ink on a print medium. The inkjet ink typically includes a colorant, such as a dye or a pigment, dispersed in an ink vehicle.

To print images having good image permanence and durability, pigment-based inkjet inks are used rather than dye-based inkjet inks. However, the images printed with the pigment-based inkjet inks typically have reduced image quality compared to those printed with the dye-based inkjet inks. One prominent image quality problem is bronzing, especially when light black (gray) or cyan (light or dark) pigment-based inkjet inks are used. If bronzing is present, the printed image has a metallic luster appearance rather than its intended color when viewed at a specular angle. The printed image also has a reduced perceived density and a tone considerably different from its desired tone. Bronzing also exacerbates other image quality problems, such as gloss nonuniformity and color imbalance.

Bronzing is caused by reflection of light from the inkjet ink when the printed image is viewed at a particular angle. Bronzing is pronounced with pigmented inkjet inks because the pigments do not penetrate into an ink-receiving layer of the print medium. Rather, the pigments form a film or layer on the ink-receiving layer. One type of bronzing is due to selective reflection of incident light at its specular angle. This type of bronzing is typically observed with cyan-pigmented inkjet inks and does not vary with the thickness of the inkjet film formed on the ink-receiving layer. Another type of bronzing is caused by interference between the light reflected from a top surface of the inkjet film and the light reflected from an interface between the inkjet film and the ink-receiving layer. This type of bronzing is typically observed with black-pigmented inkjet inks and varies with the thickness of the inkjet film. As such, bronzing is more pronounced on glossy, photobase print media compared to paperbase print media.

To reduce bronzing, color mapping (dot placement algorithm) has been used. A gloss optimizer has also been used. However, the gloss optimizer adds to the cost of the printer and to the cost per copy. Additives have also been incorporated in the print medium. Additives, such as polyurethane dispersions, have also been incorporated into the inkjet ink to reduce bronzing.

### BRIEF SUMMARY OF THE INVENTION

The present invention relates to an inkjet ink composition having reduced bronzing that includes a pigment and at least one bronzing reducing additive selected from the group consisting of a water-soluble polymer, a polymer hydrosol, a latex, a silica colloid, a titanium oxide pigment, and mixtures thereof. The at least one bronzing reducing additive is present in the inkjet ink from approximately 0.1% by weight to approximately 10% by weight of a total weight of the inkjet ink. The present invention also relates to methods of reducing bronzing and methods of formulating the subject inks.

### BRIEF DESCRIPTION OF THE SEVERAL VIEWS OF THE DRAWINGS

While the specification concludes with claims particularly pointing out and distinctly claiming that which is regarded as the present invention, the advantages of this invention can be more readily ascertained from the following description of the invention when read in conjunction with the accompanying drawing in which:

FIGS. 1 and 3 show color coordinates of high-density cyan area fill as a function of viewing angle of an embodiment of an inkjet ink according to the present invention; and

FIGS. 2 and 4 show a plot of intensity as a function of wavelength of an embodiment of an inkjet ink according to the present invention.

### DETAILED DESCRIPTION OF THE INVENTION

An inkjet ink exhibiting reduced bronzing when printed on a print medium is disclosed. In addition to exhibiting reduced bronzing, an image printed with the inkjet ink has improved gloss uniformity. To provide the reduced bronzing, the inkjet ink may include at least one bronzing reducing additive, such as a water-soluble polymer, a polymer hydrosol, a latex, a silica colloid, a titanium oxide pigment, or mixtures thereof.

Examples of water-soluble polymers that may be used as the bronzing reducing additive include, but are not limited to, an acrylic polymer, an ethylene oxide polymer, a polyurethane, a polyvinyl alcohol (“PVA”), a polyvinylpyrrolidone (“PVP”), or mixtures thereof. In one embodiment, the water-soluble polymer is a styrene/maleic anhydride copolymer having a molecular weight of 10,000 that is available from Sartomer Co. Inc. (Exton, Pa.). Acrylic polymers suitable for use in the inkjet ink are commercially available from Johnson Polymer bv (Heerenveen, The Netherlands) under the JONCRYL® tradename.

The latex may be a polystyrene latex, an acrylic latex, a styrene acrylic latex, or mixtures thereof. The latex may have a molecular weight ranging from approximately 10,000 to approximately 500,000. The latex may be synthesized by conventional techniques. Alternatively, a latex that is commercially available may be used, such as a latex from Dow Chemical Co. or Rohm & Haas (Philadelphia, Pa.). The latex may have a particle size ranging from approximately 30 nm to approximately 250 nm. In one embodiment, the bronzing reducing additive is a polystyrene latex having a particle size of 153 nm. In another embodiment, the bronzing reducing additive is a polystyrene latex having a particle size of 67 nm.

Examples of polymer hydrosols include, but are not limited to, a colloid of an acrylic polymer, an ethylene oxide polymer, a polyurethane, a PVA, a PVP, or mixtures thereof. Polymer hydrosols are spherical polymer particles dispersed in an aqueous solution. For instance, the polymer hydrosol may be a colloid of a styrene-acrylic polymer. In one embodiment, the bronzing reducing additive is a polymer hydrosol. Examples of silica colloids include, but are not limited to, colloids of silica, dispersed fumed silica, dispersed precipitated silica, or silica gel. Silica colloids are spherical silica particles dispersed in an aqueous solution. Fumed silica is prepared by burning silicon-containing compounds and forms silica particles bonded in beads or chains. Precipitated silica is prepared by treating organic silicones with caustic agents, such as potassium hydroxide, to produce small silicon dioxide particles. Silica colloids suitable for use in the inkjet ink are commercially available from Grace Davison (Columbia, Md.) under the LUDOX® tradename, such as LUDOX® AM, LUDOX® SM, or LUDOX® TM. The LUDOX® products are discrete, uniform spheres of silica that have no internal surface area or detectable crystallinity. The silica particles are dispersed in an alkaline medium, such as sodium hydroxide or ammonium hydroxide. In one embodiment, the bronzing reducing additive is a silica colloid. The titanium oxide pigments may be a colloid of titanium oxide pigments. Examples of titanium oxide pigments include titanium dioxide pigments.

The bronzing reducing additive may have a particle size that ranges from approximately 1 nm to approximately 250 nm, such as from approximately 4 nm to approximately 150 nm. In one embodiment, the particle size of the bronzing reducing additive ranges from approximately 4 nm to approximately 150 nm. If the bronzing reducing additive is the fumed silica colloid, the particle size may range from approximately 10 nm to approximately 150 nm.

The bronzing reducing additive may have an average molecular weight (“M_{w}”) ranging from approximately 3,000 to approximately 40,000. In one embodiment, the average molecular weight of the bronzing reducing additive may range from approximately 3,000 to approximately 20,000, such as from approximately 3,000 to approximately 10,000.

The bronzing reducing additive may be compatible with other ingredients of the inket ink, such as with the pigment. In addition, the bronzing reducing additive may be present in the inkjet ink in an amount effective to reduce the bronzing. The bronzing reducing additive may be present in an amount of up to approximately 10% by weight (“wt %”) of a total weight of the inkjet ink, such as from approximately 0.1 wt % to approximately 10 wt %. In one embodiment, the bronzing reducing additive is present from approximately 0.1 wt % to approximately 5 wt %. In another embodiment, the bronzing reducing additive is present from approximately 0.1 wt % to approximately 3 wt %. However, the effective amount of the bronzing reducing additive may not negatively affect desirable properties of the inkjet ink, such as the viscosity. The effective amount of the bronzing reducing additive may depend on the amount of pigment used in the inkjet ink. For instance, at high pigment concentrations, the viscosity of the inkjet ink may be increased relative to that at low pigment concentrations. Therefore, in inkjet inks having high pigment concentrations, the bronzing reducing additive may be present in a lower amount so that the bronzing reducing additive does not substantially contribute to the viscosity of the inkjet ink.

The inkjet ink may include a pigment as the colorant, which is stably dispersed in an ink vehicle. The pigment may be a conventional blue, black, brown, cyan, green, white, violet, magenta, red, orange, or yellow pigment. Pigments are well known in the art and, therefore, the pigment used in the inkjet ink of the present invention is not discussed in detail herein. The pigment may be self-dispersed in the ink vehicle by modifying the surface of the pigment to include covalent attachment of polymeric or organic groups. Alternatively, the pigment may be dispersed by using a dispersant or a surfactant. The pigment may be present in the inkjet ink in an amount sufficient to provide a desired color density when the inkjet ink is deposited on the print medium. For instance, the pigment may be present from approximately 0.1 wt % to approximately 10 wt % of the total weight of the inkjet ink.

The ink vehicle may account for approximately 70 wt % to approximately 99.8 wt % of the total weight of the inkjet ink. The ink vehicle may include water or a mixture of water and water-soluble or water-miscible organic solvents. The water soluble or water miscible organic solvents may include, but are not limited to, a polyhydric alcohol, such as ethyleneglycol, diethyleneglycol (“DEG”), triethyleneglycol (“TEG”), tetraethyleneglycol, polyethyleneglycol, and glycerol; a polyhydric alcohol ether, such as ethyleneglycolmonomethylether, ethyleneglycolmonoethylether, ethyleneglycolmonobutylether, diethyleneglycolmonoethylether, diethyleneglycolmonobutylether, and ethylene glycol monophenyl ether; a nitrogen-containing solvent, such as N-methyl-2-pyrrolidone, a substituted pyrrolidone, and triethanol amine; or mixtures thereof. Monohydric alcohols, such as methanol, ethanol, isopropyl alcohol, or mixtures thereof may also be used in the inkjet ink. The inkjet ink may also include nitrogen-containing ketones, such as 2-pyrrolidone (“2-P”), N-methyl-pyrrolid-2-one (“NMP”), 1,3-dimethylimidazolid-2-one, and octyl-pyrrolidone; diols, such as ethanediols (e.g., 1,2-ethanediol), propanediols (e.g., 1,2-propanediol, 1,3-propanediol, 2-ethyl-2-hydroxymethyl-1,3-propanediol, ethylhydroxypropanediol (“EHPD”)), butane-diols (e.g., 1,2-butanediol, 1,3-butanediol, 1,4-butanediol), pentanediols (e.g. 1,2-pentanediol, 1,5-pentanediol), hexanediols (e.g., 1,2-hexanediol, 1,6-hexanediol, 2,5-hexanediol), heptanediols (e.g., 1,2-heptanediol, 1,7-heptanediol), octanediols (e.g., 1,2-octanediol, 1,8-octanediol); alcohols, such as C₃-C₆ alcohols (e.g., propanol, butanol, pentanol, and hexanol), including isomers thereof (e.g., 1-propanol and 2-propanol); glycol ethers and thioglycol ethers commonly employed in ink-jet inks, such as polyalkylene glycols including, but limited to, propylene glycols (e.g., dipropylene glycol, tripropylene glycol, tetrapropylene glycol); polymeric glycols (e.g., PEG 200, PEG 300, PEG 400, PPG 400); thiodiglycol; and mixtures thereof. Additional organic solvents that may be used include hydantoins (glycol ureas) and derivatives thereof, such as a hydantoin containing ethyl hydroxide and methyl groups, available from Lonza, Inc. as Dantocol DHE, and polyalkoxylated triols, such as Multranol 4012, which is a polyalkoxylated triol having a molecular weight of about 440, available from Bayer. If the ink vehicle includes organic solvents, the organic solvents may be present from approximately 5% wt % to approximately 70 wt % of a total weight of the ink vehicle while the water is present from approximately 30 wt % to approximately

The ink vehicle may also include conventional additives including, but not limited to, surfactants, biocides, chelating agents, pH adjusting agents, and dispersants. The surfactant may be a nonionic, anionic, or cationic surfactant. Examples of nonionic surfactants that may be used include, but are not limited to, the TETRONIC® series available from BASF Canada (Toronto, Ontario), the TERGITOL® series available from Union Carbide Co. (Houston, Tex.), the BRIJ® series available from ICI Americas (Wilmington, Del.), the SURFYNOL® series available from Air Products (Allentown, Pa.), the TRITON® series available from Rohm & Haas (Philadelphia, Pa.), the AEROSOL® series available from Cytec Industries, Inc. (West Paterson, N.J.), the ZONYL® series of fluoropolymers available from DuPont (Wilmington, Del.), and the NEODOL® series available from Shell Chemicals, LP (Houston, Tex.). The surfactant may be present in the inkjet ink from approximately 0.01 wt % to approximately 5 wt % of the total weight of the inkjet ink.

The inkjet ink may have a pH ranging from approximately 8.5 to approximately 9.7, such as from approximately 9.0 to approximately 9.5. If the pH of the inkjet ink is below this range, the pH may be adjusted to within this range by adding, for example, sodium hydroxide, potassium hydroxide, or an organic amine, such as triethanol amine, to the inkjet ink. In one embodiment, the inkjet ink has a pH of approximately 9.2.

The inkjet ink may be formulated by grinding or milling the pigment and dispersing the pigment, as known in the art. The other ingredients, such as the bronzing reducing additive or any conventional additives that may be present, may be mixed and dissolved into the ink vehicle using conventional techniques. For instance, the ingredients of the inkjet ink may be mixed using a ball mill, a sand mill, a roll mix, an agitator mill, a Henschel mixer, a colloid mill, or an ultrasonic homogenizer.

The inkjet ink of the present invention may be used to print images in an inkjet printing process, such as a thermal, piezoelectric, drop-on-demand, or continuous inkjet printing process. The inkjet ink may be deposited on the print medium using a conventional inkjet printer. Inkjet printers are known in the art and, therefore, are not described in detail herein. For the sake of example only, the inkjet printer may be an HP DeskJet printer, available from Hewlett-Packard Co., (Palo Alto, Calif.).

After the inkjet ink is deposited on the print medium, the extent of bronzing may be determined by several methods. For instance, the bronzing may be determined using a goniospectrophotometer, in which an incident beam is directed on a sample at a particular angle and the color coordinates of the reflected beam are measured at different viewing angles. The extent of color variation may be used to characterize the bronzing. A second method of determining the extent of bronzing is to use a colorimeter with spherical geometry. In this type of calorimeter, color coordinates of a sample may be measured by excluding or including the specular reflection component. When the specular component is included, the color coordinates (L*ᵢₙ, a*ᵢₙ, b*ᵢₙ) may be similar to the color viewed at the specular reflection angle. When the specular component is excluded, the color coordinates (L*ₑₓ, a*ₑₓ, b*ₑₓ) may be similar to the color viewed at a nonspecular angle. The vector chroma difference measured in these two conditions may be calculated by the following formula:
Delta H=sqrt((a*ᵢₙ−a*ₑₓ)²+(b*ᵢₙ−b*ₑₓ)²).
The Delta H may used to characterize the bronzing. The contribution of L* may be neglected in this formula because it does not contribute to the bronzing.

When the inkjet ink is deposited on the print medium, a thin, ink film forms on a surface. Without being bound to a particular theory, it is believed that the bronzing reducing additive in the inkjet ink may alter the packing structure of the pigment in the ink film. The bronzing reducing additive may interfere with packing morphology of the pigment as the inkjet ink is deposited. For the sake of example only, if the bronzing reducing additive is the silica colloid, particles of the silica may change the orientation of the pigment, making the reflection surface more randomized. The resulting ink film may be less structured or may form a less organized lattice than an ink film deposited with a conventional inkjet ink. The silica particles may alter the direction of light reflected from the ink film/paper coating interface, so that the light reflected from the ink film/air interface is not canceled by the light reflected from the lower ink film/coating interface. The bronzing reducing additive may also alter the ink film thickness, making the otherwise destructive interaction between the two beams reflected from the two interfaces not destructive, reducing the extent of bronzing.

The following examples serve to explain embodiments of the present invention in more detail. These examples are not to be construed as being exhaustive or exclusive as to the scope of this invention.

### EXAMPLES

### Example 1

### Cyan and Light Cyan Inkjet Formulations with a Styrene-Acrylic Polymer as the Bronzing Reducing Additive

Cyan inkjet formulations A-D having the ingredients shown in Table 1 were produced by mixing together the ingredients shown in Table 1. If the pH of the inkjet formulations was below 9.0, the pH was adjusted to a pH of 9.0 or above with sodium hydroxide. The inkjet formulations were applied to a glossy, silica-based porous print medium.

TABLE 1
Cyan Inkjet Formulations Including a Styrene-Acrylic
Polymer as the Bronzing Reducing Additive.

| | No | With | No | With |
|---|---|---|---|---|
| | Additive | Additive | Additive | Additive |
| Inkjet Formulation | A | B | C | D |
| Liponics | 3.5 | 3.5 | 3.5 | 3.5 |
| ethoxylated | | | | |
| glycol | | | | |
| 1-(2-hydroxyeth- | 4.5 | 4.5 | 4.5 | 4.5 |
| yl)-2-pyrrolidone | | | | |
| (wt %) | | | | |
| DEG (wt %) | 2 | 2 | 2 | 2 |
| 1,2-hexanediol | 4 | 4 | 4 | 4 |
| (wt %) | | | | |
| Surfactant (wt %) | 0.5 | 0.5 | 0.5 | 0.5 |
| Surfactant (wt %) | 0.25 | 0.25 | 0.25 | 0.25 |
| Surfactant (wt %) | 0.2 | 0.2 | 0.2 | 0.2 |
| PROXEL ® GXL | 0.15 | 0.15 | 0.15 | 0.15 |
| (wt %) | | | | |
| Cyan Pigment | 3 | 3 | 1 | 1 |
| (wt %) | | | | |
| Styrene-acrylic | 0 | 1 | 0 | 1 |
| polymer (wt %) | | | | |
| Deionized water | Balance | Balance | Balance | Balance |

Liponics ethoxylated glycol is an ethoxylated glycerin dispersant, which is available from Lipo Chemical Co. (Paterson, N.J.). PROXEL® GXL is a biocide that includes a solution of 1,2-benzisothiazolin-3-one (BIT), sodium hydroxide, and dipropylene glycol and is available from Avecia Ltd. The styrene-acrylic polymer was JONCRYL® 586. lnkjet formulations A and C included no styrene-acrylic polymer while inkjet formulations B and D included the styrene-acrylic polymer. The cyan pigment was present in inkjet formulations C and D at a low loading (1 wt %), forming the light cyan inkjet inks, and in inkjet formulations A and B at a high loading (3 wt %), forming the cyan inkjet inks.

Images were printed with each of Formulations A-D on glossy photo media, such as Epson Premium Glossy Photopaper, PICTORICO® Photo Gallery Glossy Paper, or a print medium having an alumina basecoat and a silica topcoat. To determine the extent of bronzing, a goniospectrophotometer was used to measure CIELAB values at an incident angle of 300 and view angles that changed from −45° and 60°, as known in the art. In the CIELAB color space, a color is defined using three terms: L*, a*, and b*. L* defines the lightness of a color, and ranges from zero (black) to 100 (white). The terms a* and b*, together, define the hue. The term a* ranges from a negative number (green) to a positive number (red). The term b* ranges from a negative number (blue) to a positive number (yellow).

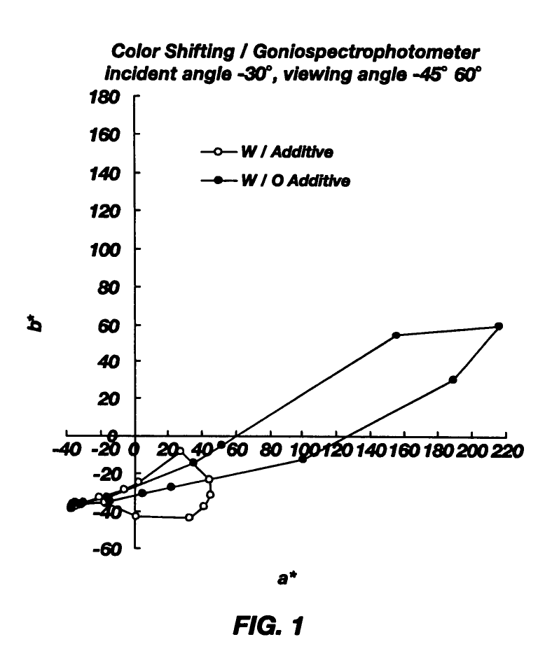

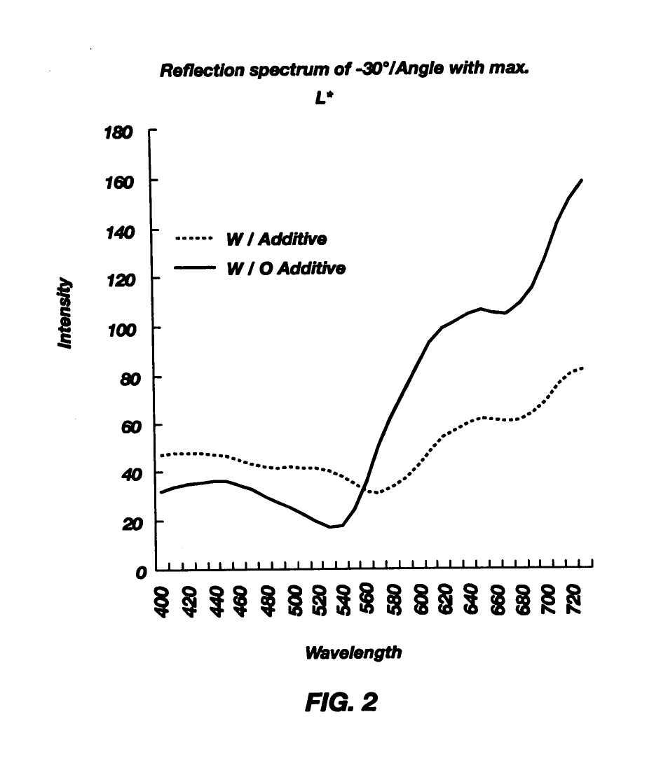

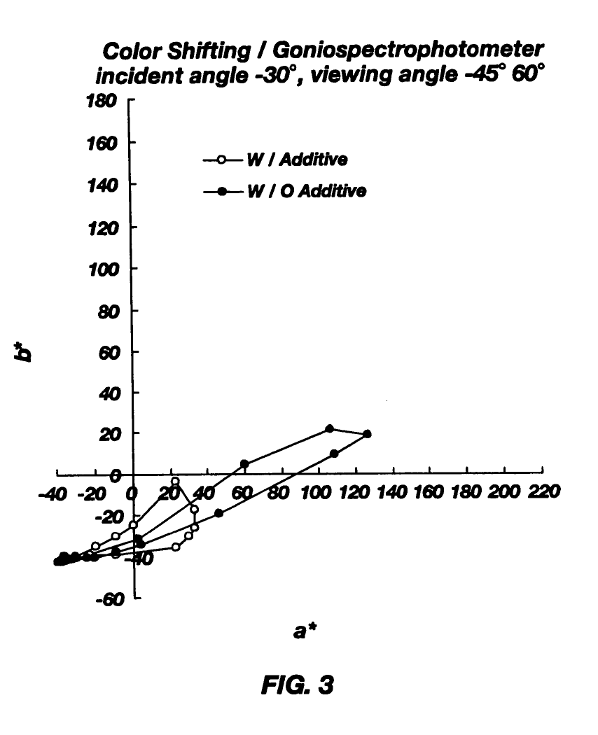

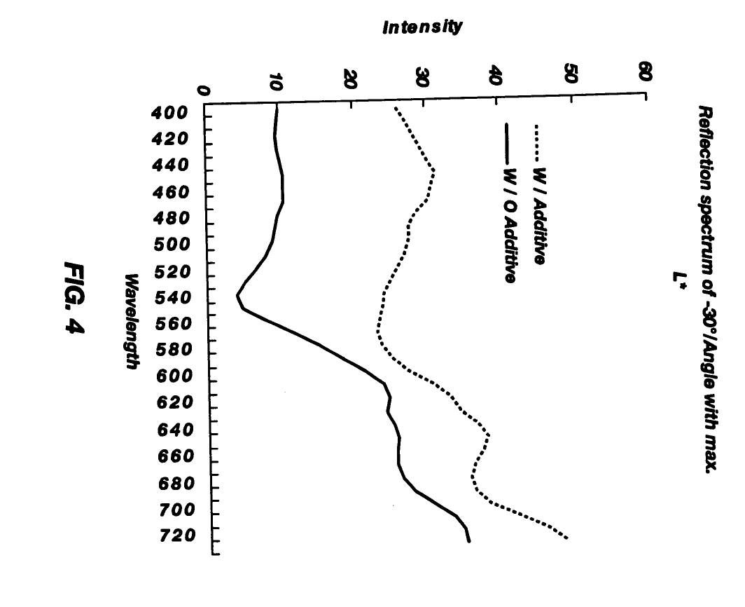

The b* values were plotted as a function of the a* values for the light and dark inkjet formulations, as shown in FIGS. 1 and 3. In addition, intensity was plotted as a function of wavelength for the light and dark inkjet formulations, as shown in FIGS. 2 and 4. The results for the light cyan inkjet inks are shown in FIGS. 1 and 2 and for the dark inkjet inks are shown in FIGS. 3 and 4.

The inkjet formulations having the styrene-acrylic polymer exhibited substantially less color variation when viewed at different angles than the inkjet formulations lacking the styrene-acrylic polymer. Therefore, the bronzing of the inkjet formulations with the styrene acrylic polymer was substantially less than the inkjet formulations lacking the styrene-acrylic polymer.

### Example 2

### Light Gray and Light Cyan Inkjet Formulations with a Styrene-Acrylic Polymer, a Latex, or a Colloidal Silica as the Bronzing Reducing Additive

A stock formulation having the ingredients shown in Table 2 was prepared. The ingredients shown in Table 2 were mixed together to produce 500 g of Stock Formulation 1.

TABLE 2
Composition of Stock Formulation 1.

| Ingredient | Weight percent |
|---|---|
| Liponic ethoxylated glycol | 3 |
| 2-pyrrolidone | 6 |
| Glycerol | 5 |
| 1,2-hexanediol | 7 |
| Surfactant | 0.65 |
| Surfactant | 0.19 |
| Proxel ™ GXL | 0.15 |
| Deionized water | 3.01 |
| Total | 25 |

The Stock Formulation 1 was used in producing light gray.(“L_{g}”) inkjet inks (Formulations Z1-Z8 L_{g}) and light cyan (“L_{c}”) inkjet inks (Formulations Z1-Z8 L_{c}) by mixing Stock Formulation 1 with the ingredients shown in Tables 3 and 4. The “total pigment” referred to in Table 3 refers to a mixture of pigments that includes pigments of any color.

TABLE 3
Light Gray Inkjet Formulations Z1-Z8 L_{g} Including a Styrene Acrylic
Polymer, LUDOX ®, or a Latex as the Bronzing Reducing Additive.

| Inkjet Formulation | Z1 L_{g} | Z2 L_{g} | Z3 L_{g} | Z4 L_{g} | Z5 L_{g} | Z6 L_{g} | Z7 L_{g} | Z8 L_{g} |
|---|---|---|---|---|---|---|---|---|
| Stock Formulation 1 (grams) | 25 | 25 | 25 | 25 | 25 | 25 | 25 | 25 |
| Total pigment (grams) | 0.75 | 0.75 | 0.75 | 0.75 | 0.75 | 0.75 | 0.75 | 0.75 |
| Sugar (grams) | 2.00 | | | | | | | |
| Styrene acrylic polymer, 20% (grams) | 9.00 | 9.00 | 9.00 | | | | | |
| Triethynol amine (grams) | | | 1.00 | | | | | |
| LUDOX ® SM-30 (31.22% silica dispersed in water) (grams) | | | | 6.41 | | | | |
| LUDOX ® TM-50 (52.1% silica dispersed in water) (grams) | | | | | 3.84 | | | |
| LUDOX ® AM-30 (31.92% silica dispersed in water) (grams) | | | | | | 6.27 | | |
| Polystyrene latex-1 (31.87%) (grams) | | | | | | | 6.28 | |
| Polystyrene latex-2 (35.49%) (grams) | | | | | | | | 5.64 |
| DDI water (grams) | Balance | Balance | Balance | Balance | Balance | Balance | Balance | Balance |

TABLE 4
Light Cyan Inkjet Formulations Z1-Z8 L_{c} Including a Styrene Acrylic
Polymer, LUDOX ®, or a Latex as the Bronzing Reducing Additive.

| Ink ID | Z1 L_{c} | Z2 L_{c} | Z3 L_{c} | Z4 L_{c} | Z5 L_{c} | Z6 L_{c} | Z7 L_{c} | Z8 L_{c} |
|---|---|---|---|---|---|---|---|---|
| Stock Formulation 1 (grams) | 25 | 25 | 25 | 25 | 25 | 25 | 25 | 25 |
| Cyan pigment PB 15:3 (grams) | 0.75 | 0.75 | 0.75 | 0.75 | 0.75 | 0.75 | 0.75 | 0.75 |
| Sugar (grams) | 2.00 | | 2.00 | | | | | |
| Styrene acrylic polymer, 20% (grams) | 9.00 | 9.00 | 9.00 | | | • | | |
| Triethynol amine (grams) | | | 1.00 | | | | | |
| LUDOX ® SM-30 (31.22%) (grams) | | | | 6.41 | | | | |
| LUDOX ® TM-50 (52.1%) (grams) | | | | | 3.84 | | | |
| LUDOX ® AM-30 (31.92%) (grams) | | | | | | 6.27 | | |
| Polystyrene latex-1 (31.87%) (grams) | | | | | | | 6.28 | |
| Polystyrene latex-2 (35.49%) (grams) | | | | | | | | 5.64 |
| DDI water (grams) | Balance | Balance | Balance | Balance | Balance | Balance | Balance | Balance |

As previously described, the LUDOX® products are silica colloids. Polystyrene latex-1 had a particle size of 153 nm and polystyrene latex-2 had a particle size of 67 nm. A styrene acrylic polymer, LUDOX® SM, LUDOX® TM, LUDOX® AM, polystyrene latex-1, and polystyrene latex-2 were each tested as the bronzing reducing additive. Inkjet formulations Z1-Z3 L_{g} and Z1-Z3 L_{c} included 1.8% of the bronzing reducing additive(s) and Inkjet formulations Z4-Z8 L_{g} and Z4-Z8 L_{c} included 2% of the bronzing reducing additive(s). If the pH of the inkjet formulations was below 9.2, the pH was adjusted to 9.2 or above with sodium hydroxide. A control ink formulation lacking the bronzing reducing additive was also produced.

To determine the extent of bronzing, sixteen images (known as chips) were printed on glossy photo media with each of the inkjet formulations shown in Tables 3 and 4. The sixteen chips were of increasing color density. As such, each chip had a different ink load. A ramp of the ink load was printed from 0%-100% in 16 equal steps. The chips were printed on a silica-based print medium, an alumina-based print medium, or a PICTORICO® print medium. Since bronzing of light gray inkjet inks is less pronounced at low color density or at high color density, the chips having a middle color density (chip numbers 5-10 out of the 16 chips) were used to determine the extent of bronzing. A calorimeter, such as a Macbeth colorimeter available from MacBeth (a division of Kollmorgen Instruments Corp., New Windsor, N.Y.), was used to measure the L*, a*, and b* CIELAB values using standard color measurement procedures, as known in the art. These values were then used to calculate an average change in hue (“ΔH”), as known in the art. The average ΔH values for the inkjet formulations are shown in Tables 5-10.

TABLE 5
Average ΔH Values for the Light Gray Inkjet Formulations
Printed on an Alumina-based Porous Print Medium.

| Average of Delta H | Color |
|---|---|
| Ink | L_{g} |
| Control | 5.54 |
| Z3 | 3.14 |
| Z4 | 0.82 |
| Z5 | 0.77 |
| Z6 | 0.79 |
| Z7 | 0.27 |
| Z8 | 0.45 |

TABLE 6
Average ΔH Values for the Light Gray Inkjet Formulations
Printed on a Silica-based Porous Print Medium.

| Average of Delta H | Color |
|---|---|
| Ink | L_{g} |
| Control | 4.0 |
| Z3 | 1.9 |
| Z4 | 0.9 |
| Z5 | 0.7 |
| Z6 | 0.8 |
| Z7 | 0.5 |
| Z8 | 0.6 |

TABLE 7
Average ΔH Values for the Light Gray Inkjet Formulations
Printed on a PICTORICO ® Porous Print Medium.

| Average of Delta H | Color |
|---|---|
| Ink | L_{g} |
| Control | 5.1 |
| Z3 | 4.2 |
| Z4 | 0.8 |
| Z5 | 0.5 |
| Z6 | 0.7 |
| Z7 | 0.3 |
| Z8 | 0.4 |

TABLE 8
Average ΔH Values for the Light Cyan Inkjet Formulations
Printed on an Alumina-based Porous Print Medium.

| Average of Delta H | Color |
|---|---|
| Ink | L_{c} |
| Control | 8.5 |
| Z3 | 6.9 |
| Z4 | 3.7 |
| Z5 | 2.3 |
| Z6 | 3.5 |
| Z7 | 0.6 |
| Z8 | 0.8 |

TABLE 9
Average ΔH Values for the Light Cyan Inkjet Formulations
Printed on a Silica-based Porous Print Medium.

| Average of Delta H | Color |
|---|---|
| Ink | L_{c} |
| Control | 8.6 |
| Z3 | 4.3 |
| Z4 | 3.5 |
| Z5 | 2.5 |
| Z6 | 3.4 |
| Z7 | 0.8 |
| Z8 | 1.2 |

TABLE 10
Average ΔH Values for the Light Cyan Inkjet Formulations
Printed on PICTORICO ® Porous Print Medium.

| Average of Delta H | Color |
|---|---|
| Ink | L_{c} |
| Control | 8.78 |
| Z3 | 4.62 |
| Z4 | 4.15 |
| Z5 | 3.39 |
| Z6 | 4.32 |
| Z7 | 0.91 |
| Z8 | 1.15 |

The control inkjet formulations exhibited bronzing when printed on the silica-based porous print medium, the alumina-based porous print medium, or the PICTORICO® print medium. In contrast, the inkjet formulations having the styrene acrylic polymer, the LUDOX®, or the polystyrene latex as the bronzing reducing additive typically exhibited reduced bronzing when printed on the same print media.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. An inkjet ink having reduced bronzing, comprising:
a pigment and at least one bronzing reducing additive selected from the group consisting of a water-soluble polymer, a polymer hydrosol, a latex, a silica colloid, a titanium oxide pigment, and mixtures thereof, wherein the at least one bronzing reducing additive is present in the inkjet ink in an amount ranging from approximately 0.1% by weight to approximately 10% by weight of a total weight of the inkjet ink.

2. The inkjet ink of claim 1, wherein the at least one bronzing reducing additive comprises a styrene/maleic anhydride polymer, a styrene-acrylic polymer, or an acrylic polymer.

3. The inkjet ink of claim 1, wherein the at least one bronzing reducing additive comprises colloids of silica, fumed silica, precipitated silica, or silica gel dispersed in an aqueous solution.

4. The inkjet ink of claim 1, wherein the at least one bronzing reducing additive is present in an amount ranging from approximately 0.1% by weight to approximately 5% by weight of the total weight of the inkjet ink.

5. The inkjet ink of claim 1, wherein the at least one bronzing reducing additive has a particle size ranging from approximately 1 nm to approximately 250 nm.

6. The inkjet ink of claim 1, wherein the at least one bronzing reducing additive has a molecular weight ranging from approximately 3,000 to approximately 40,000.

7. A method of reducing bronzing, comprising:
providing an inkjet ink comprising a pigment and at least one bronzing reducing additive selected from the group consisting of a water-soluble polymer, a polymer hydrosol, a latex, a silica colloid, a titanium oxide pigment, and mixtures thereof, wherein the at least one bronzing reducing additive is present in the inkjet ink in an amount ranging from approximately 0.1% by weight to approximately 10% by weight of a total weight of the inkjet ink; and
depositing the inkjet ink on an ink-receiving layer of a print medium.

8. The method of claim 7, wherein depositing the inkjet ink on the ink-receiving layer of the print medium comprises forming a film of the inkjet ink on the ink-receiving layer.

9. The method of claim 7, wherein depositing the inkjet ink on the ink-receiving layer of the print medium comprises deposing the inkjet ink on a silica-based porous print medium, an alumina-based porous print medium, or a porous print medium having an alumina basecoat and a silica topcoat.

10. The method of claim 7, wherein providing the inkjet ink comprising the pigment and the at least one bronzing reducing additive comprises providing the pigment and a polymer selected from the group consisting of styrene/maleic anhydride polymer, a styrene-acrylic polymer, an acrylic polymer, and mixtures thereof.

11. The method of claim 7, wherein providing the inkjet ink comprising the pigment and the at least one bronzing reducing additive comprises providing the pigment and colloids of silica, fumed silica, precipitated silica, or silica gel dispersed in an aqueous solution.

12. The method of claim 7, wherein providing the inkjet ink comprising the pigment and the at least one bronzing reducing additive comprises providing the at least one bronzing reducing additive in an amount ranging from approximately 0.1% by weight to approximately 5% by weight of the total weight of the inkjet ink.

13. The method of claim 7, wherein providing the inkjet ink comprising the pigment and the at least one bronzing reducing additive comprises providing the at least one bronzing reducing additive at a particle size ranging from approximately 1 nm to approximately 250 nm.

14. The method of claim 7, wherein providing the inkjet ink comprising the pigment and the at least one bronzing reducing additive comprises providing the at least one additive having a molecular weight ranging from approximately 3,000 to approximately 40,000.

15. A method of formulating an inkjet ink having reduced bronzing, comprising:
dispersing a pigment in an ink vehicle; and
adding at least one bronzing reducing additive selected from the group consisting of a water-soluble polymer, a polymer hydrosol, a latex, a silica colloid, a titanium oxide pigment, and mixtures thereof to the ink vehicle, wherein the at least one bronzing reducing additive is present in the inkjet ink in an amount ranging from approximately 0.1% by weight to approximately 10% by weight of a total weight of the inkjet ink.

16. The method of claim 15, wherein adding the at least one bronzing reducing additive selected from the group consisting of a water-soluble polymer, a polymer hydrosol, a latex, a silica colloid, a titanium oxide pigment, and mixtures thereof to the ink vehicle comprises adding a styrene/maleic anhydride polymer, a styrene-acrylic polymer, or an acrylic polymer to the ink vehicle.

17. The method of claim 15, wherein adding the at least one bronzing reducing additive selected from the group consisting of a water-soluble polymer, a polymer hydrosol, a latex, a silica colloid, a titanium oxide pigment, and mixtures thereof to the ink vehicle comprises adding colloids of silica, fumed silica, precipitated silica, or silica gel dispersed in an aqueous solution to the ink vehicle.

18. The method of claim 15, wherein adding the at least one bronzing reducing additive selected from the group consisting of a water-soluble polymer, a polymer hydrosol, a latex, a silica colloid, a titanium oxide pigment, and mixtures thereof to the ink vehicle comprises adding the at least one bronzing reducing additive in an amount ranging from approximately 0.1% by weight to approximately 5% by weight of the total weight of the inkjet ink.

19. The method of claim 15, wherein adding the at least one bronzing reducing additive selected from the group consisting of a water-soluble polymer, a polymer hydrosol, a latex, a silica colloid, a titanium oxide pigment, and mixtures thereof to the ink vehicle comprises adding the at least one bronzing reducing additive in a particle size ranging from approximately 1 nm to approximately 250 nm.

20. The method of claim 15, wherein adding the at least one bronzing reducing additive selected from the group consisting of a water-soluble polymer, a polymer hydrosol, a latex, a silica colloid, a titanium oxide pigment, and mixtures thereof to the ink vehicle comprises adding the at least one bronzing reducing additive having a molecular weight ranging from approximately 3,000 to approximately 40,000.
